(19) United States
(12) Patent Application Publication
(10) Pub. No.: US 2008/0133173 A1
(43) Pub. Date: Jun. 5, 2008

(54) METHOD AND SYSTEM FOR MEASURING AN IMAGE OF AN OBJECT

(75) Inventors: CHIH-KUANG CHANG, Tu-Cheng (TW); ZHONG-KUI YUAN, Shenzhen (CN); LI JIANG, Shenzhen (CN); XIAO-CHAO SUN, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Shenzhen City (CN)

(21) Appl. No.: 11/850,038

(22) Filed: Sep. 5, 2007

(30) Foreign Application Priority Data
Dec. 5, 2006 (CN) 200610201210.2

(51) Int. Cl. G01B 11/02

(52) U.S. Cl. 702/155

(57) ABSTRACT

A system for measuring an image of an object is provided. The system includes a measuring machine and an application server. The application server includes: an edge searching module for finding outlines of an image of an under-measurement object based on gray scale of points in the image and around the image; a measuring module for constructing an applicable coordinate system for the image, and computing structural data of structural patterns of the image using the constructed coordinate system; and a process recording module for recording measuring process as a corresponding procedure instruction while measuring the under-measurement object and generating an automatic measurement program according to the procedure instruction. A related method is also disclosed.

### BACKGROUND OF THE INVENTION

1. Field of the Invention

The present invention is generally related to systems and methods of measurement, especially related to a system and a method for image measuring.

2. General Background

Product quality is one of the most important factors in maintaining manufacturer competitiveness. How to improve the quality of products is an important ongoing pursuit of the manufacturers. It is essential to verify the correctness and accuracy of prototype samples before a batch production. Conventionally, the verification is achieved by manual work. The manual work can slow down efficiency, increase errors, and can seriously affect the accuracy and consistency of the verification.

In recent years, with the performance of computer hardware and software continually improving and with the prices of such equipment becoming more inexpensive, computers are now used for image measuring with a measuring machine to verify accuracy and consistency of an object.

However the current method for image measuring by using the computer associated with the measuring machine has disadvantages. For example, it is necessary to repeat the same operations when measuring the same objects and the measurement results cannot be visually reflected.

Accordingly, what is needed is a system and method for image measuring, which can edit program code automatically for finishing the same measurement, and display measurement results visually.

### SUMMARY OF THE INVENTION

A system for measuring an image of an object is provided. The system includes a measuring machine and an application server. The application server includes: an edge searching module configured for finding outlines of an image of an under-measurement object based on gray scales of points in the image and around the image, wherein the image is captured and transmitted from the measuring machine; a measuring module configured for constructing an applicable coordinate system for the image, and computing structural data of structural patterns of the image using the constructed coordinate system, wherein the structural patterns comprises points, lines, and circles of the image, and the structural data comprises coordinate values of the points, coordinate values of the starting point of each line, coordinate values of the midpoint of each line, coordinate values of the end point of each line, the direction of each line, straightness of each line, coordinate values of the center point of each circle, the radius of each circle, the diameter of each circle, circular degree of each circle; and a process recording module configured for recording measuring process as a corresponding procedure instruction while the measuring machine is measuring the under-measurement object and generating an automatic measurement program according to the procedure instruction.

A method for measuring an image of an object is provided. The method includes the steps of: (a) acquiring an image of an under-measurement object captured and transmitted from a measuring machine; (b) finding outlines of the image based on gray scales of points in the image and around the image; (c) measuring the image by constructing an applicable coordinate system for the image, and computing structural data of structural patterns of the image using the constructed coordinate system, wherein the structural patterns comprises points, lines, and circles of the image, and the structural data comprises coordinate values of the points; coordinate values of the starting point of each line, coordinate values of the midpoint of each line, coordinate values of the end point of each line, the direction of each line, straightness of each line, coordinate values of the center point of each circle, the radius of each circle, the diameter of each circle, circular degree of each circle; and (d) saving process from step (a) to step (c) and compiling the process into an automatic measurement program.

Other advantages and novel features of the present invention will become more apparent from the following detailed description of preferred embodiments when taken in conjunction with the accompanying drawings, in which:

### BRIEF DESCRIPTION OF THE DRAWINGS

FIG. 1 is a schematic diagram of hardware configuration of a system for measuring an image of an object in accordance with a preferred embodiment of the present invention;

FIG. 2 is a schematic diagram of main software function modules of an application server of FIG. 1;

FIG. 3 is a flowchart of a method for measuring an image of an object in accordance with a preferred embodiment of the present invention; and

FIG. 4 is a flowchart of a method for automatically measuring an image of the same object of FIG. 3 by using an automatic measurement program in accordance with a preferred embodiment of the present invention.

### DETAILED DESCRIPTION OF THE INVENTION

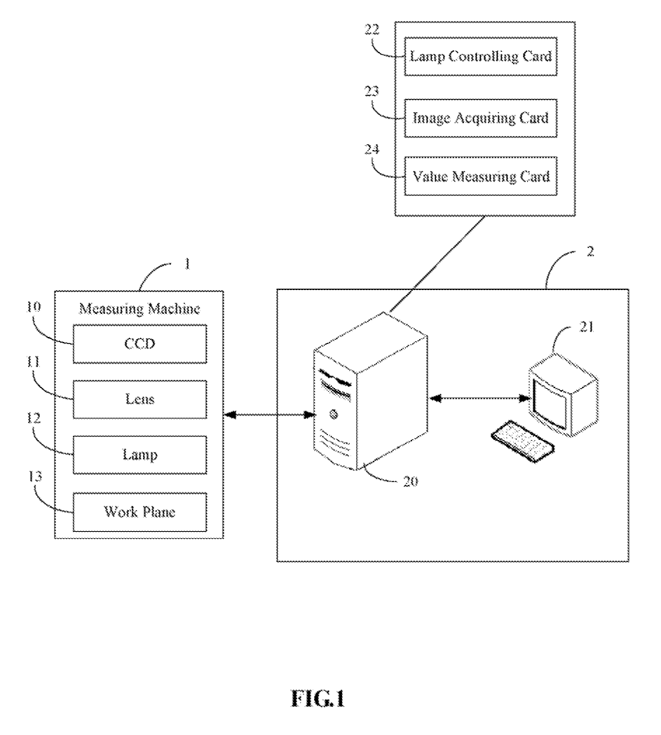

FIG. 1 is a schematic diagram of hardware configuration of a system for measuring an image of an object (hereinafter, “the system”) in accordance with a preferred embodiment of the present invention. The system typically includes a measuring machine 1 and a computer system 2. The measuring machine 1 includes: a CCD (charge coupled device) 10, a lens 11, a lamp 12, and a work plane 13. The work plane 13 is used for placing an under-measurement object. The lamp 12 is used for providing different kinds of lamplight for the under-measurement object at different angles, such as ring light, outline light, and coaxial light etc. The CCD 10 is used for capturing an image of the under-measurement object that is focused by the lens 11, and for transmitting the captured image to the computer system 2. The computer system 2 includes a client computer 21 and an application server 20 which receives the captured image transmitted from the CCD 10.

The client computer 21 provides an operational interface mainly for displaying an operational status of the system. The client computer 21 may be a desktop computer or a laptop computer.

The application server 20 mainly includes: a lamp controlling card 22, an image acquiring card 23, and a value measuring card 24. The lamp controlling card 22 is structured and arranged for controlling the lamp 12 of the measuring machine 1 to provide different kinds of lamplight at different angles. The image acquiring card 23 is structured and arranged for acquiring the image of the under-measurement object transmitted from the CCD 10. The value measuring card 24 is structured and arranged for computing coordinate values of measured points in the acquired image using a current coordinate system. The application server 20 further includes a plurality of software function modules for measuring the acquired image, and for compiling whole measuring process into an automatic measuring program. The automatic measurement program can be invoked to measure the same objects automatically. The application server 20 communicates with the client computer 21 and the measuring machine 1.

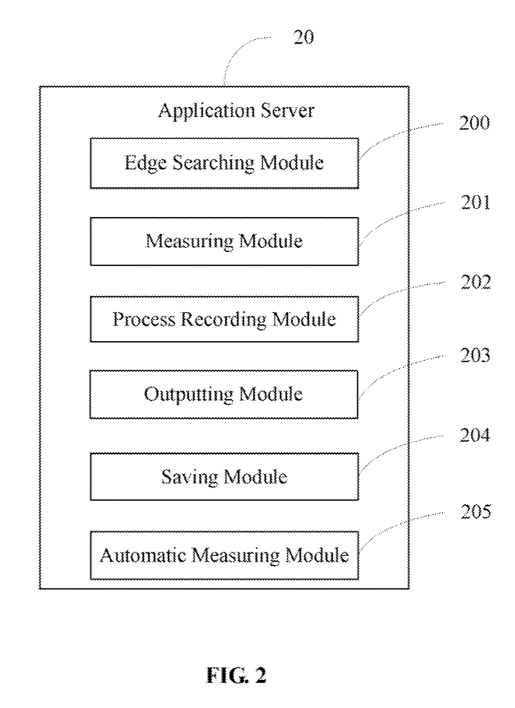

FIG. 2 is a schematic diagram of main software function modules of the application server 20. The application server 20 mainly includes an edge searching module 200, a measuring module 201, a process recording 202, an outputting module 203, a saving module 204, and an automatic measuring module 205.

The edge searching module 200 is configured for finding outlines of the image based on gray scales of points in the image and around the image.

The measuring module 201 is configured for constructing an applicable coordinate system for the image, and computing structural data of structural patterns in the image using the constructed coordinate system. The applicable coordinate system is constructed by using a mechanical coordinate system of the measuring machine 1 as a reference coordinate system, and translating the reference coordinate system into the applicable coordinate system. The applicable coordinate system may take the center point of the image as an origin. The structural patterns of the image include points, lines, circles, etc. The structural data of the structural patterns may include coordinate values of the points, coordinate values of the starting point of each line, coordinate values of the midpoint of each line, coordinate values of the end point of each line, the direction of each line, straightness of each line, coordinate values of the center point of each circle, the radius of each circle, the diameter of each circle, circular degree of each circle etc.

The process recording module 202 is configured for recording measuring processes as a corresponding procedural instruction while the measuring machine 1 measures the image of the under-measurement object. Specifically, the process recording module 202 generates the procedural instruction of the measuring processes, and compiles the procedure instruction into an automatic measuring program. For performing the measuring processes, some basic parameters are required such as the positioning coordinates of the lens 11, and other related operational information such as measuring structural patterns and so on.

The outputting module 203 is configured for displaying measuring results dynamically. The measuring results may include the constructed coordinate system, the structural patterns (points, lines, circles, and so on) of the image, the structural data of the structural patterns, and the automatic measurement program.

The saving module 204 is configured for storing the measuring results into a memory of the application server 20.

The automatic measuring module 205 is configured for invoking the automatic measurement program to measure the same objects.

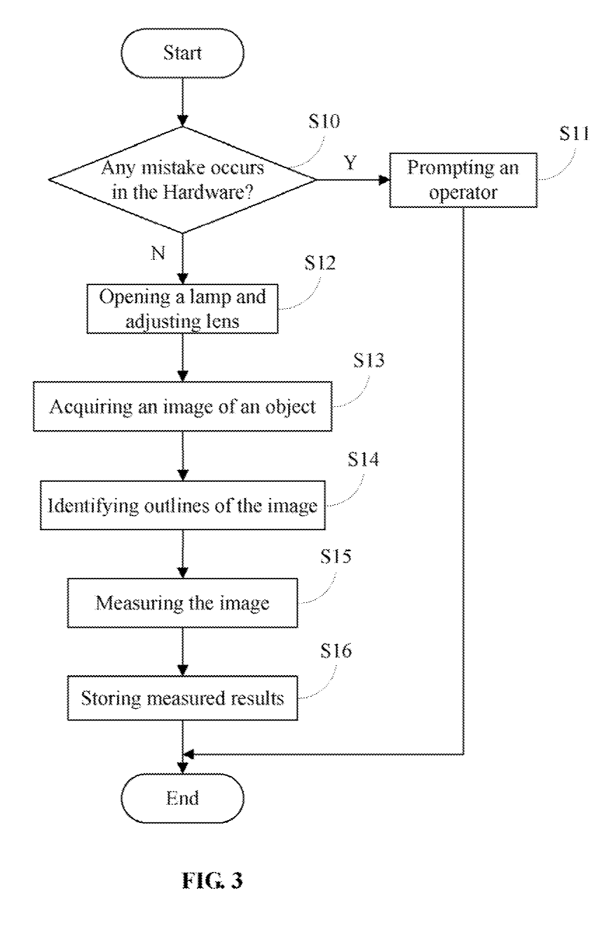

FIG. 3 is a flowchart of a method for measuring an image of an object in accordance with a preferred embodiment of the present invention.

In step S10, the system is activated, and the measuring machine 1 is automatically enabled. If any error occurs during the measuring machine 1 enabling moment, in step S11, error information is prompted to the operator. Otherwise, if no errors occur during the measuring machine 1 enabling moment, in step S12, the operator turns on the lamp 12 of the measuring machine 1, and adjusts the lens 11 through moving the measuring machine 1. The lamp 12 can provide lamplight at different angles to help the lens 11 to focus the lamplight on the under-measurement object.

In step S13, the lens 11 focuses the lamplight on the under-measured object placed on the measuring machine 1. The CCD 10 captures an image of the under-measured object and transmits the captured image to the application server 20. The image acquiring card 23 installed in the application server 20 acquires the image transmitted from the CCD 10. The image acquired by the image acquiring card 23 can be shown on the client computer 21.

In step S14, the edge searching module 200 finds outlines of the image based on gray scales of points in the image and around the image.

In step S15, the measuring module 201 measures the image, including constructing an applicable coordinate system for the image, computing structural data of structural patterns of the image using the constructed coordinate system. After the measurement of the image, the outputting module 203 displays the constructed coordinate system, the structural patterns and the structural data on the client computer 21. The coordinate system is constructed by using a mechanical coordinate system of the measuring machine 1 as a reference coordinate system, and translating the reference coordinate system into the applicable coordinate system. The applicable coordinate system may take the center point of the image as an origin. The structural patterns of the image include points, lines, circles etc. The structural data includes: coordinate values of the points, coordinate values of the starting point of each line, coordinate values of the midpoint of each line, coordinate values of the end point of each line, the direction of each line, straightness of each line, coordinate values of the center point of each circle, the radius of each circle, the diameter of each circle, circular degree of each circle etc.

In step S16, the saving module 204 stores measured results into a memory of the application server 20, wherein the measured results include the constructed coordinate systems, the structural patterns of the image, the structural data, and so on.

In addition, in order to conveniently measure the same objects, the process of measuring the image, from step S12 to step S15 may be recorded by the process recording module 202, and be compiled into an automatic measurement program.

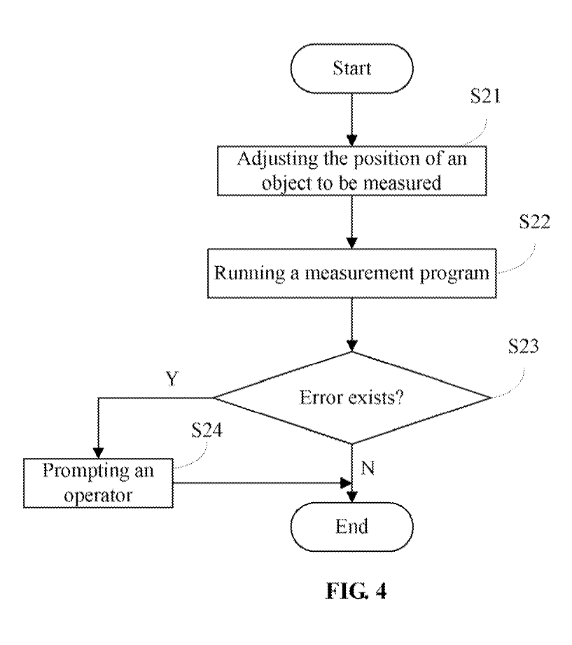

FIG. 4 is a flowchart of a method for automatically measuring an image of the same object by using the automatic measurement program in accordance with a preferred embodiment of the present invention.

In step S21, the operator adjusts the position of the under-measured object manually, so that the lens 11 can focus the lamplight on the under-measured object. Once the lamplight is focused on the under-measured object, the CCD 10 captures an image of the under-measured object, and transmits the image to the image acquiring card 23. In step S22, the automatic measuring module 205 measures the image of the under-measured object automatically by running the automatic measurement program.

In step S23, the automatic measuring module 205 determines whether any mistake exists during measurement, for example, the image acquiring card 23 can not acquire the image of the under-measured object from the CCD 10.

If any mistake exists, the automatic measuring module 205 sends a dialog box, which includes mistake information to prompt the operator, and then, the process ends. Otherwise, if no mistake exists during the measurement, the process ends when the image of the object is measured completely.

Although the present invention has been specifically described on the basis of a preferred embodiment and a preferred method, the invention is not to be construed as being limited thereto. Various changes or modifications may be made to said embodiment and method without departing from the scope and spirit of the invention.

What is claimed is:

1. A system for measuring an image of an object, comprising a measuring machine and an application server, the application server comprising:
an edge searching module configured for finding outlines of an image of an under-measurement object based on gray scales of points in the image and around the image, wherein the image is captured and transmitted from the measuring machine;
a measuring module configured for constructing an applicable coordinate system for the image, and computing structural data of structural patterns of the image using the constructed coordinate system, wherein the structural patterns comprises points, lines, and circles of the image, and the structural data comprises coordinate values of the points, coordinate values of the starting point of each line, coordinate values of the midpoint of each line, coordinate values of the end point of each line, the direction of each line, straightness of each line, coordinate values of the center point of each circle, the radius of each circle, the diameter of each circle, circular degree of each circle; and
a process recording module configured for recording measuring process as a corresponding procedure instruction while the measuring machine measures the under-measurement object and generating an automatic measurement program according to the procedure instruction.

2. The system as claimed in claim 1, wherein the application server further comprises:
an outputting module configured for displaying the constructed coordinate systems, the structural patterns of the image, the structural data of the structural patterns, and the automatic measurement program; and
a saving module configured for storing the constructed coordinate systems, the structural patterns of the image, the structural data of the structural patterns, and the automatic measurement program.

3. The system as claimed in claim 1, wherein the application server further comprises:
an automatic measuring module configured for invoking the automatic measurement program for measuring the same objects.

4. A method for measuring an image of an object, the method comprising:
(a) acquiring an image of an under-measurement object captured and transmitted from a measuring machine;
(b) finding outlines of the image based on gray scales of points in the image and around the image;
(c) measuring the image by constructing an applicable coordinate system for the image, and computing structural data of structural patterns of the image using the constructed coordinate system, wherein the structural patterns comprises points, lines, and circles of the image, and the structural data comprises coordinate values of the points; coordinate values of the starting point of each line, coordinate values of the midpoint of each line, coordinate values of the end point of each line, the direction of each line, straightness of each line, coordinate values of the center point of each circle, the radius of each circle, the diameter of each circle, circular degree of each circle; and
(d) saving process from step (a) to step (c) and compiling the process into an automatic measurement program.

5. The method according to claim 4, further comprising:
(e) outputting and storing the constructed coordinate system, the structural patterns, the structural data of the structural patterns, and the automatic measurement program in the application server.

6. The method according to claim 4, further comprising: automatically measuring the same objects using the automatic measurement program generated in step (d).
